(19) United States
(12) Patent Application Publication
(10) Pub. No.: US 2015/0093069 A1
(43) Pub. Date: Apr. 2, 2015

(54) SEMICONDUCTOR LASER MODULE AND METHOD OF MANUFACTURING THE SAME

(71) Applicants: Oki Electric Industry Co., Ltd., Tokyo (JP); Photonics Electronics Technology Research Association, Tokyo (JP)

(72) Inventor: Koji NAKAMURA, Tokyo (JP)

(73) Assignees: OKI ELECTRIC INDUSTRY CO., LTD., Tokyo (JP); Photonics Electronics Technology Research Association, Tokyo (JP)

(21) Appl. No.: 14/309,114

(22) Filed: Jun. 19, 2014

(30) Foreign Application Priority Data
Sep. 30, 2013 (JP) 2013-203405

(51) Int. Cl. G02B 6/42

(52) U.S. Cl. CPC G02B 6/4228
USPC 385/14; 438/26

(57) ABSTRACT

There is provided a semiconductor laser module with a semiconductor laser chip, in which a first optical waveguide is formed, flip-chip mounted on a silicon substrate with a mesa structure in which a second optical waveguide is formed. The optical axes of the first optical waveguide and the second optical waveguide make a specified angle with lines perpendicular to the respective cleavage planes. Alignment marks are provided on the silicon substrate and the semiconductor laser chip at at least two positioning locations to enable mounting of the semiconductor laser chip by passive alignment. The mounting position is decided so that laser light emitted in a direction of the optical axis of the first optical waveguide and refracted at the emission surface, is refracted at the incident surface of the second optical waveguide and becomes incident in the direction of the optical axis of the second optical waveguide.

### CROSS REFERENCE TO RELATED APPLICATION(S)

This application is based upon and claims benefit of priority from Japanese Patent Application No. 2013-203405, filed on Sep. 30, 2013, the entire contents of which are incorporated herein by reference.

### BACKGROUND

The present invention relates to a semiconductor laser module produced by optically coupling a waveguide-type semiconductor laser and an optical waveguide and to a method of manufacturing the same.

In the field of semiconductor laser modules produced by forming, on a silicon substrate, an optical waveguide used to connect an optical cable and optically coupling such optical waveguide to the optical waveguide of a waveguide-type semiconductor laser, attention has been given to a method of flip-chip mounting a semiconductor laser chip using passive alignment. By using such method of flip-chip mounting using passive alignment, an active alignment task of carrying out fine adjustment of individual installation positions while having laser light emitted becomes unnecessary, which improves the manufacturing efficiency of semiconductor laser modules and can reduce the manufacturing cost.

In the field of optical interconnects where the properties of high bandwidth, low latency, and low power consumption are highly valued, there is demand for a high-density and low-cost mounting technology, and Fabry-Perot (FP)-type semiconductor lasers with multiple longitudinal-mode oscillation are often used.

Meanwhile, to carry out multichannel communication by multiplexing wavelengths and/or long distance communication, distributed feedback (DFB)-type semiconductor lasers with single longitudinal-mode oscillation are used instead of FP-type semiconductor lasers. However, DFB-type semiconductor lasers have a disadvantage in that they are easily affected by reflected return light from outside, causing deterioration in the quality of light during transfer. For this reason, when semiconductor laser modules have been configured using DFB-type semiconductor lasers, it has been normal to provide an optical isolator for blocking the reflected return light between the optical waveguide and the semiconductor laser. However, when miniaturizing a module, space constraints make it difficult to install an optical isolator and there is also an increase in cost, so that DFB-type semiconductor lasers have not been used in semiconductor laser modules with silicon optical waveguides.

Hatori Nobuaki et al., “A Hybrid Integrated Light Source on A Si substrate Using A Trident Spot-size Converter”, May 2012, Technical Report of Institute of Electronics, Information and Communication Engineers (ICICE), Vol. 112, no. 62, LQE 2012-4, p. 15-20 discloses a spot size converting technology for improving coupling efficiency and tolerance for positioning displacements when a semiconductor laser element is flip-chip mounted on a substrate on which a silicon waveguide is formed. However, the light source used in this case is an FP-type semiconductor laser.

### SUMMARY

On a silicon substrate, it is possible to form a driver for driving a semiconductor laser and electronic circuits such as a processing circuit for signals received by an optical receiver. Accordingly, by forming such electronic circuits and an optical waveguide on a silicon substrate and mounting a semiconductor laser light source and an optical receiver, it is possible to configure a so-called “photonics-electronics convergent device”.

However, since silicon is an indirect transition semiconductor, it is difficult to use silicon itself as a light source. For this reason, a method that uses a semiconductor laser produced using a group III-V semiconductor such as InP as a light source and optically couples such light source and an optical waveguide made of silicon (hereinafter abbreviated to “Si waveguide”) has been proposed. When optically coupling the Si waveguide and the group III-V semiconductor laser, it is possible to reduce the manufacturing cost by flip-chip mounting that uses passive alignment.

Since photonics-electronics convergent devices have hitherto been mainly targeted at interconnections, FP-type semiconductor lasers have been used as the light source. Since FP-type semiconductor lasers are hardly affected by reflected return light, it has not been especially necessary to implement measures against reflected return light.

Meanwhile, in cases where an FP-type semiconductor laser is used in single-longitudinal-mode oscillation to carry out multiplexed-wavelength communication and long distance communication, a method has been used where an external resonator is formed by an Si waveguide and the wavelength is controlled. However, with such method, since the construction becomes complex, there are the problems that it is difficult to miniaturize the apparatus and that the extinction ratio of light signals is insufficient.

For this reason, although a method that uses light produced by directly modulating the output of a DFB-type semiconductor laser, which fundamentally operates in single longitudinal-mode oscillation, would be conceivable, there has been the problem that DFB-type semiconductor lasers are easily affected by reflected return light.

The present invention aims to provide, at low cost, a semiconductor laser module that is hardly affected by reflected return light.

According to an aspect of the present invention, there is provided a semiconductor laser module which includes: a semiconductor laser chip in which a first optical waveguide for guiding laser light to be emitted is formed; and a silicon substrate provided with a mesa structure in which a second optical waveguide is formed, wherein the semiconductor laser chip is flip-chip mounted on the silicon substrate, an optical axis of the first optical waveguide makes a specified angle with a line perpendicular to a cleavage plane of the semiconductor laser chip that is an emission surface of the first optical waveguide, an optical axis of the second optical waveguide makes the specified angle with a cleavage plane of the mesa structure that is an incident surface of the second optical waveguide, and alignment marks are provided on the silicon substrate and the semiconductor laser chip corresponding to at least two positioning locations to enable the semiconductor laser chip to be mounted by passive alignment at a mounting position of the semiconductor laser chip on the silicon substrate, the mounting position having been decided so that laser light, which has been emitted in a direction of the optical axis of the first optical waveguide and refracted at the emission surface, is refracted at the incident surface of the second optical waveguide and becomes incident in a direction of the optical axis of the second optical waveguide.

According to another aspect of the present invention, there is provided a semiconductor laser module which includes: a semiconductor laser chip in which a first optical waveguide for guiding laser light to be emitted is formed; and a silicon substrate provided with a mesa structure in which a second optical waveguide is formed, wherein the semiconductor laser chip is flip-chip mounted on the silicon substrate, an optical axis of the first optical waveguide makes a specified angle with a line perpendicular to a cleavage plane of the semiconductor laser chip that is an emission surface of the first optical waveguide, the cleavage plane of the semiconductor laser chip and a cleavage plane of the mesa structure that is an incident surface of the second optical waveguide are parallel, an optical axis of the second optical waveguide is set so as to be parallel to refracted light produced when laser light emitted in a direction of the optical axis of the first optical waveguide and refracted at the emission surface of the first optical waveguide is refracted and becomes incident at the incident surface of the second optical waveguide, and alignment marks are provided on the silicon substrate and the semiconductor laser chip corresponding to at least two positioning locations to enable the semiconductor laser chip to be mounted by passive alignment at a mounting position of the semiconductor laser chip on the silicon substrate, the mounting position having been decided so that laser light, which has been emitted in a direction of the optical axis of the first optical waveguide and refracted at the emission surface, is refracted at the incident surface of the second optical waveguide and becomes incident in a direction of the optical axis of the second optical waveguide.

According to yet another aspect of the present invention, there is provided a method of manufacturing the semiconductor laser module described above, which includes mounting the semiconductor laser chip by passive alignment at the mounting position of the semiconductor laser chip on the silicon substrate using the alignment marks provided on the silicon substrate and the semiconductor laser chip.

According to the aspects of the present invention described above, it is possible to provide, at low cost, a semiconductor laser module that is hardly affected by reflected return light.

### BRIEF DESCRIPTION OF THE DRAWINGS

FIG. 1A is a view showing an example configuration of a semiconductor laser module according to an embodiment of the present invention, and is a plan view showing the entire configuration;

FIG. 1B is a view showing an example configuration of a semiconductor laser module according to an embodiment of the present invention, and is a view showing an enlargement of part of the configuration;

FIG. 2A is a plan view showing an example configuration of a waveguide-type semiconductor laser chip;

FIG. 2B is a view showing an example configuration of a waveguide-type semiconductor laser chip, and is a cross-sectional view showing an example of the laminated structure in the direction of the optical axis of an optical waveguide;

FIG. 3A is a plan view showing an example configuration of a silicon substrate on which an optical waveguide and a bump electrode are formed;

FIG. 3B is a view showing an example configuration of a silicon substrate on which an optical waveguide and a bump electrode are formed, and is a cross-sectional view showing an example of the laminated structure in the direction of the optical axis of the optical waveguide;

FIG. 4A is a view useful in explaining optical coupling of the optical waveguide of the semiconductor laser chip and the optical waveguide of the silicon substrate, and is an enlarged plan view useful in explaining optical coupling with an optical waveguide that has a spot size converter mechanism;

FIG. 4B is a view useful in explaining optical coupling of the optical waveguide of the semiconductor laser chip and the optical waveguide of the silicon substrate, and is an enlarged plan view useful in explaining the positional relationship between the optical waveguides in a first embodiment;

FIG. 4C is a view useful in explaining optical coupling of the optical waveguide of the semiconductor laser chip and the optical waveguide of the silicon substrate, and is an enlarged plan view useful in explaining the positional relationship between the optical waveguides in a second embodiment;

FIG. 5A is a view showing an example configuration of an existing semiconductor laser module, and is a plan view showing the entire configuration; and

FIG. 5B is a view showing an example configuration of an existing semiconductor laser module, and is a view showing an enlargement of part of the configuration.

### DETAILED DESCRIPTION OF THE EMBODIMENT(S)

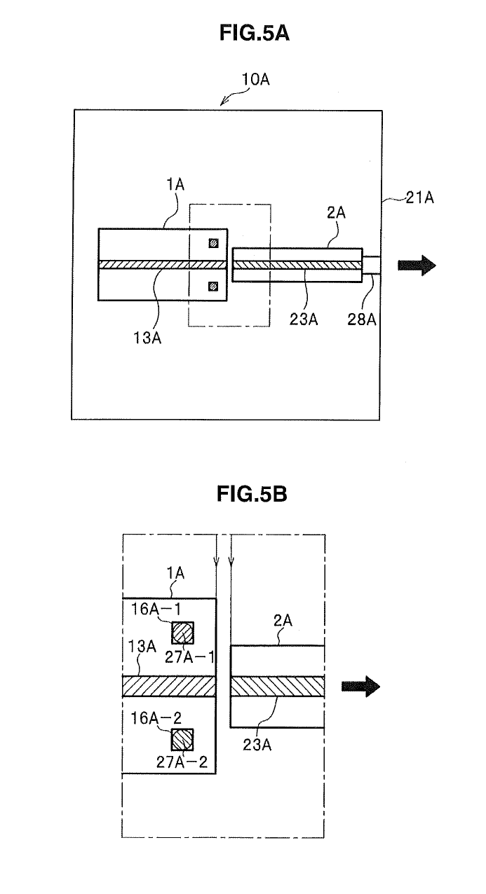

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted. FIG. 5A and FIG. 5B are views showing an example configuration of an existing semiconductor laser module, with FIG. 5A a plan view of the entire configuration and FIG. 5B an enlarged view of part of such configuration.

Many existing semiconductor laser modules use FP-type semiconductor lasers, which are hardly affected by reflected return light, as a light source. In such case, as shown in FIG. 5A, a semiconductor laser module 10A is normally designed so that an optical waveguide 13 of a semiconductor laser chip 1A and a Si waveguide 23A formed on a silicon substrate 21A, which both have an optical axis that is perpendicular to the cleavage plane, are disposed facing one another and optically coupled. By doing so, provided that the gap between the optical waveguides 13A and 23A is the same, even if the optical axes of the waveguides are somewhat displaced, the drop in coupling efficiency will be reduced, which means it is possible to increase the tolerance for positioning displacements. Note that in the example shown in FIG. 5A, on the silicon substrate 21A, a mesa structure 2A with a specified laminated structure including the Si waveguide 23A is formed and an optical connector portion 28A for optically coupling to an external optical cable is also mounted.

Also, as shown in FIG. 5B, alignment marks 27A-1, 27A-2, which are circular for example, are printed on the surface of the silicon substrate 21A and hole portions 16A-1, 16A-2, which are square for example and pass through the semiconductor laser chip 1A, are formed on the semiconductor laser chip 1A. By simultaneously positioning the two pairs, that is, a pair of the alignment mark 27A-1 and the hole portion 16A-1 and a pair of the alignment mark 27A-2 and the hole portion 16A-2, using an optical sensor, the mounting position of the semiconductor laser chip 1A is adjusted. By doing so, the semiconductor laser chip 1A is mounted at a specified position on the silicon substrate 21A by passive alignment.

However, if a DFB-type semiconductor laser that is easily affected by reflected return light is used as the light source, with an arrangement such as that shown in FIG. 5A, there is the problem that the reflected return light will have a large effect, which prevents the necessary coupling efficiency from being obtained.

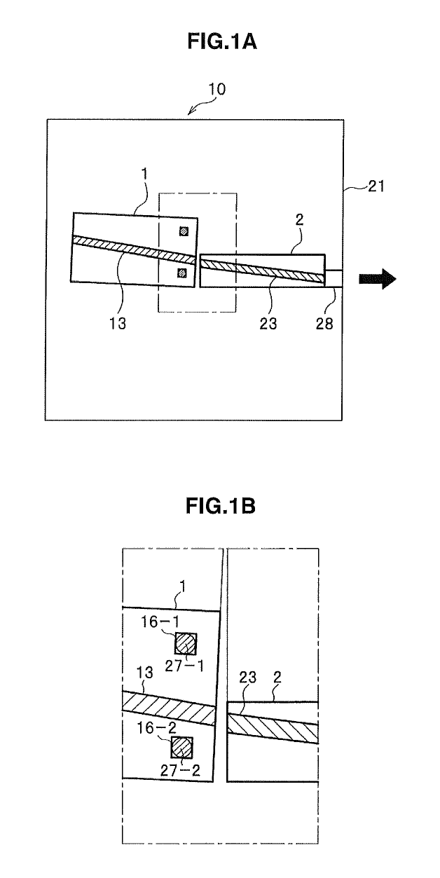

For this reason, in the semiconductor laser module according to the present invention, to reduce the effect of reflected return light, as shown in FIG. 1A, both an optical waveguide 13 of a semiconductor laser chip 1 and a Si waveguide 23 formed on a silicon substrate 21 are provided at an angle. FIG. 1A and FIG. 1B are views showing an example configuration of a semiconductor laser module according to an embodiment of the present invention, with FIG. 1A a plan view showing the entire configuration and FIG. 1B a view showing an enlargement of part of such configuration. As shown in FIG. 1A, in a semiconductor laser module 10 according to the present embodiment, the optical axes of both the optical waveguide 13 of the semiconductor laser chip 1 and the Si waveguide 23 formed on the silicon substrate 21 are provided at an angle of a specified value or higher with respect to lines perpendicular to the respective cleavage planes that are the emission surface and incident surface of laser light.

By doing so, since reflected return light that is emitted from the Si waveguide 23 in the opposite direction to the direction of the optical axis of the Si waveguide 23 will be partially reflected at the cleavage plane of the Si waveguide 23 and the cleavage plane of the optical waveguide 13 that is disposed opposite, it is possible to reduce the amount of light incident on the optical waveguide 13. In addition, by making the spot size of the Si waveguide 23 larger than the spot size of the optical waveguide 13 at the coupled surfaces, it is possible to further reduce the proportion of reflected return light that is incident on the optical waveguide 13. As a result, it is possible to reduce the amount of reflected return light incident on the optical waveguide 13 to a level that is not problematic even when a DFB-type semiconductor laser is used as the light source. Note that in the example in FIG. 1A, on the silicon substrate 21, a mesa structure 2 with a specified laminated structure including the Si waveguide 23 is formed and an optical connector portion 28 for optically coupling to an external optical cable is also mounted.

Also, as shown in FIG. 1B, alignment marks 27-1, 27-2, which are circular for example, are printed on the surface of the silicon substrate 21 and hole portions 16-1, 16-2, which are square for example and pass through the semiconductor laser chip 1, are formed on the semiconductor laser chip 1. By simultaneously positioning the two pairs, that is, a pair of the alignment mark 27-1 and the hole portion 16-1 and a pair of the alignment mark 27-2 and the hole portion 16-2, using an optical sensor, the mounting position of the semiconductor laser chip 1A is adjusted. By doing so, the semiconductor laser chip 1 is mounted at a specified position on the silicon substrate 21 by passive alignment.

Note that when the optical waveguides 13, 23 are provided at an angle as shown in FIG. 1A and FIG. 1B, since the gap between the optical waveguides 13, 23 will also change if the optical axes of both waveguides are displaced in the up-down direction in the drawings, the peak position of laser light in the optical axis direction will also be displaced. For this reason, by setting the printed positions of the alignment marks 27-1, 27-2 with further consideration to the displacement of such peak position, it is possible to reduce the drop in coupling efficiency.

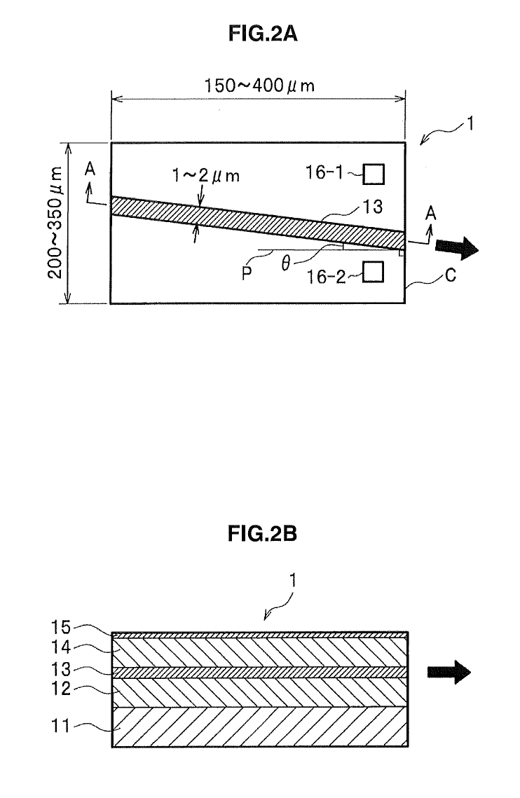

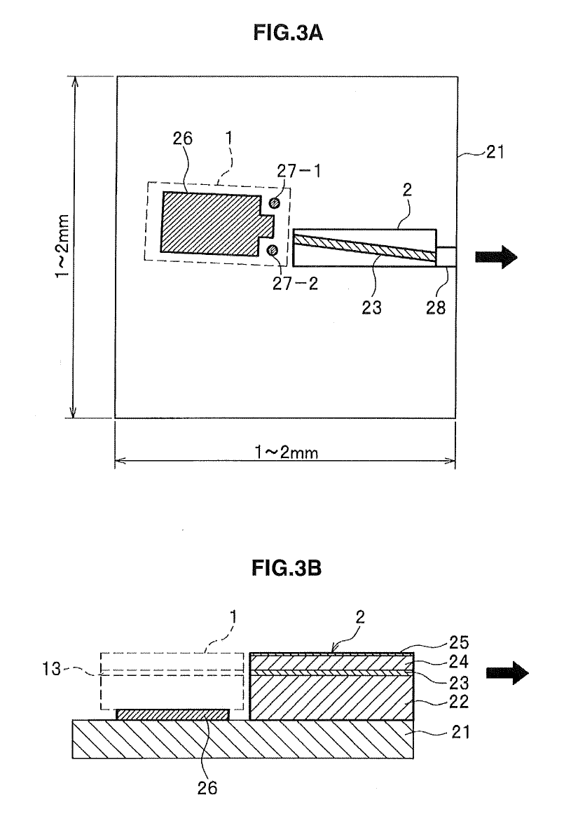

FIG. 2A and FIG. 2B are views showing an example configuration of a waveguide-type semiconductor laser chip according to an embodiment of the present invention, where FIG. 2A is a plan view and FIG. 2B is a cross-sectional view showing an example of the laminated structure in the direction of the optical axis of the optical waveguide. As shown in FIG. 2A, the optical waveguide 13 (whose emission direction is indicated by the black arrow) and the hole portions 16-1, 16-2 used for positioning with the alignment marks 27-1, 27-2 on the silicon substrate 21 (see FIG. 3A) are provided on the semiconductor laser chip 1.

The optical waveguide 13 is formed so that the optical axis thereof makes a specified angle θ to a perpendicular line P perpendicular to the cleavage plane C of the semiconductor laser chip 1 that is the emission surface for laser light. Although the angle θ should preferably be set within a range of around 5° to 15°, the angle θ may be outside this range.

FIG. 2B is a cross-sectional view along the direction A-A in FIG. 2A and shows an example of the laminated structure in the direction of the optical axis of the optical waveguide 13. As shown in FIG. 2B, the semiconductor laser chip 1 is configured for example by laminating an n-type InP cladding layer 12, the optical waveguide 13 which is made up of an active layer of InGaAsP, a p-type InP cladding layer 14, and an InGaAsP cap layer 15 in that order on an n-type InP substrate 11. By providing a pair of electrodes (omitted from the drawing) for applying a voltage to the optical waveguide (active layer) 13 on an upper surface of the cap layer 15 and the lower surface of the substrate 11 and carrying out on/off control of the voltage applied to both electrodes, the emission timing of laser light from the emission surface of the optical waveguide 13 is controlled.

Also, in the DFB-type semiconductor laser chip 1, a diffraction grating (omitted from the drawing) for guiding laser light of only a specified wavelength is provided at the boundary part between the active layer that constructs the optical waveguide 13 and either the cladding layer 12 or the cladding layer 14.

Note that although the optical waveguide 13 that is made up of an active layer is drawn with an exaggerated width in FIG. 2A, in reality, the width of the optical waveguide 13 is merely 1-2 μm, compared to the size of the semiconductor laser chip 1 which has a length of 150 to 400 μm and a width of 200 to 350 μm.

FIG. 3A and FIG. 3B are views showing an example configuration of a silicon substrate on which an optical waveguide and a bump electrode are formed, with FIG. 3A a plan view and FIG. 3B a cross-sectional view showing an example of a laminated structure in the direction of the optical axis of the optical waveguide. As shown in FIG. 3A, on the silicon substrate 21, the mesa structure 2 in which the Si waveguide 23 is formed, the bump electrode 26, and an optical connector portion 28 are provided.

The bump electrode 26, which is made up of a plurality of bumps for supplying power or various control signals to the semiconductor laser chip 1, is provided at a joining surface where the semiconductor laser chip 1, whose mounting position is shown by a broken line, is joined. The optical connector portion 28 is used to optically couple the Si waveguide 23 and an external optical cable.

The Si waveguide 23 is formed inside the mesa structure 2 laminated on the silicon substrate 21 as a rib, a ridge, or a thin wire which is covered with an insulated layer of SiO₂ or the like. As one example, the laminated structure of the mesa structure 2 is produced by laminating a cladding layer 22 made of SiO₂, the Si waveguide 23 that is a core layer, a cladding layer 24 made of SiO₂, and a cap layer 25 as a protective film in that order on the silicon substrate 21.

Also, as described later, at an end portion on the semiconductor laser chip 1 side that is the incident surface of the Si waveguide 23, it is preferable to provide a spot size converter mechanism for increasing the coupling efficiency by matching the spot size of the optical waveguide 13 and the spot size of the Si waveguide 23.

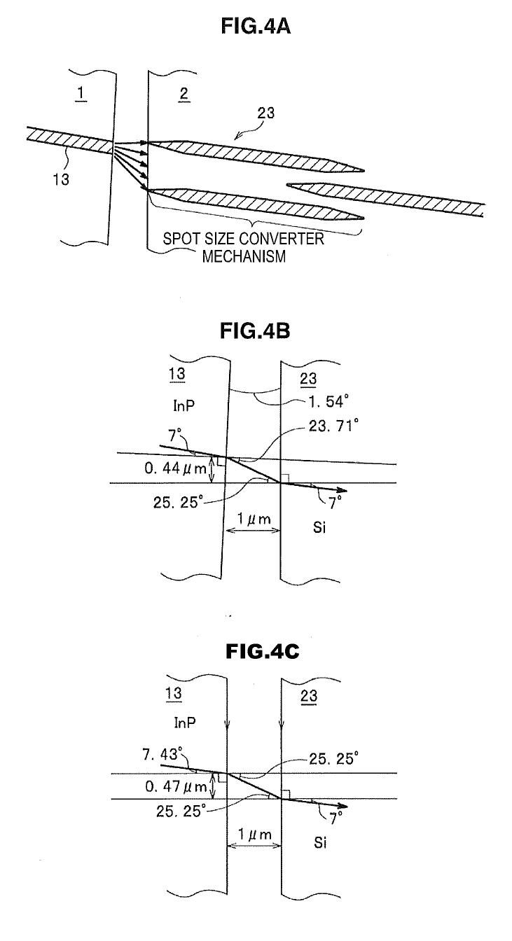

FIG. 4A, FIG. 4B, and FIG. 4C are views useful in explaining the optical coupling between the optical waveguide of the semiconductor laser chip and the optical waveguide of the silicon substrate. FIG. 4A is an enlarged plan view useful in explaining optical coupling with an optical waveguide that has a spot size converter mechanism and FIG. 4B and FIG. 4C are diagrams useful in explaining the positional relationship between the optical waveguides according to first and second embodiments, respectively.

As shown in FIG. 4A, laser light that has been guided by the optical waveguide 13 of the semiconductor laser chip 1 is emitted from the emission surface that is the cleavage plane of the semiconductor laser chip 1 with a specified spread in keeping with the spot size. For this reason, a trident-shaped waveguide, for example, with a spot size converter function is provided at an incident end of the Si waveguide 23 that is the optical waveguide on the silicon substrate 21 side (the mesa structure 2). Such trident-shaped waveguide is configured from three waveguides that have front end portions on a taper, and by guiding the laser light incident between the two outer waveguides to the middle waveguide, the spot size of the incident light is converted.

Accordingly, by setting the spot size at the incident surface of the Si waveguide 23 larger than the spot size of the optical waveguide 13 so as to substantially cover the spread of the laser light in keeping with the gap between the optical waveguide 13 and the Si waveguide 23, it is possible to reduce the drop in coupling efficiency. Meanwhile, since the reflected return light from the Si waveguide 23 is emitted from the cleavage plane of the mesa structure 2 with a spread in keeping with the spot size, it is possible to make the proportion of return light incident on the optical waveguide 13 even smaller than the ratio of the two spot sizes.

FIG. 4B shows the positional relationship between the optical waveguides in the first embodiment. In this first embodiment, the optical axis of the optical waveguide 13 which is made of InP and formed on a substrate 11 of the semiconductor laser chip 1 and the optical axis of the Si waveguide 23 that is formed on the silicon substrate 21 are both set so as to make an angle of 7° to lines perpendicular to the cleavage planes of the respective substrates.

When doing so, it is possible to estimate the emission angle from the emission surface of the optical waveguide 13 and the incident angle on the incident surface of the Si waveguide 23 from the refractive indices of the materials forming the respective waveguides. As one example, if the refractive index of the InP material that forms the optical waveguide 13 for a communication wavelength band is 3.3, the emission angle from the optical waveguide 13 will be around 23.71°. Also, if the refractive index of Si for the same communication wavelength band is 3.5, the incident angle on the Si waveguide 23 will be around 25.25°. Accordingly, the semiconductor laser chip 1 should be mounted on the silicon substrate 21 so as to be inclined by around 1.54°, which is the difference between the two angles. Also, if the gap in the left-right direction in the drawing when optically coupling the semiconductor laser chip 1 and the Si waveguide 23 is assumed to be 1.0 nm, center points of the facing end surfaces of the optical waveguide 13 and the Si waveguide 23 will be displaced by around 0.44 nm in the up-down direction in the drawing. For this reason, the angle of inclination of the semiconductor laser chip 1 is set by slightly inclining the positions of the alignment marks 27-1, 27-2 printed on the silicon substrate 21 in the left-right direction so that the distance between the center points of the two waveguides is the calculated value (see FIG. 3A).

FIG. 4C shows the positional relationship between the optical waveguides in the second embodiment. In this second embodiment, the cleavage planes of the semiconductor laser chip 1 and the mesa structure 2 on the silicon substrate 21 are parallel to one another and the optical axis of the Si waveguide 23 is set so as to make an angle of 7° to a line perpendicular to the cleavage plane of the mesa structure 2.

Here, if the same materials are used as in the first embodiment described above, since the incident angle on the Si waveguide 23 is around 25.25° and the cleavage planes of the semiconductor laser chip 1 and the mesa structure 2 are parallel to one another, the emission angle from the optical waveguide 13 will also be around 25.25°. From back calculation from such emission angle using the refractive index 3.3 of the InP material that forms the optical waveguide 13, an angle of around 7.43° is made between the optical axis of the optical waveguide 13 and a line perpendicular to the cleavage plane of the semiconductor laser chip 1. Accordingly, the optical waveguide 13 is formed so that the optical axis of the optical waveguide 13 makes the calculated angle. Also, in this case, the center points of the facing end surfaces of the optical waveguide 13 and the Si waveguide 23 will be displaced by around 0.47 μm in the up-down direction in the drawing. For this reason, the positions in the up-down direction of the alignment marks 27-1, 27-2 printed on the silicon substrate 21 are set so that the distance between the center points of the two waveguides is the calculated value when the angle of inclination of the semiconductor laser chip 1 is zero.

As described above, according to the embodiments of the present invention, by providing both the optical waveguide 13 of the semiconductor laser chip 1 and the Si waveguide 23 at an angle in a semiconductor laser module, it is possible to reduce the effect of reflected return light at the coupling surfaces of both waveguides. Since it also becomes possible to flip-chip mount the semiconductor chip using passive alignment, it is possible to reduce the manufacturing cost of the semiconductor laser module 10. In addition, by providing a spot size converter mechanism on the Si waveguide 23 side, it is possible to increase the tolerance for positioning displacements when positioning using the alignment marks 27-1, 27-2 and the hole portions 16-1, and 16-2.

Note that although examples that use a DFB-type semiconductor laser have been described in the embodiments given above, the present invention is also capable of being applied to a DBR (Distributed Bragg Reflector)-type semiconductor laser that uses Bragg reflection. Also, although an example where the spot size converter mechanism is provided on the Si waveguide side has been described in the embodiments given above, a spot size converter mechanism may be provided on the optical waveguide side of the semiconductor laser chip, and spot size converter mechanisms may be provided on both sides or omitted from both sides.

Also, although an example where pairs of alignment marks, which each include a circle and a square and which are provided at two positioning locations, are positioned using an optical sensor has been described in the embodiments given above, the number of positioning locations may be three or more. It is also possible to use alignment marks of an arbitrary shape. In addition, the positioning method is not limited to a method that uses an optical sensor and as one example may be a method that physically fits pairs of alignment marks into one another.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A semiconductor laser module comprising:
a semiconductor laser chip in which a first optical waveguide for guiding laser light to be emitted is formed; and
a silicon substrate provided with a mesa structure in which a second optical waveguide is formed,
wherein the semiconductor laser chip is flip-chip mounted on the silicon substrate,
an optical axis of the first optical waveguide makes a specified angle with a line perpendicular to a cleavage plane of the semiconductor laser chip that is an emission surface of the first optical waveguide,
an optical axis of the second optical waveguide makes the specified angle with a cleavage plane of the mesa structure that is an incident surface of the second optical waveguide, and
alignment marks are provided on the silicon substrate and the semiconductor laser chip corresponding to at least two positioning locations to enable the semiconductor laser chip to be mounted by passive alignment at a mounting position of the semiconductor laser chip on the silicon substrate, the mounting position having been decided so that laser light, which has been emitted in a direction of the optical axis of the first optical waveguide and refracted at the emission surface, is refracted at the incident surface of the second optical waveguide and becomes incident in a direction of the optical axis of the second optical waveguide.

2. A semiconductor laser module comprising:
a semiconductor laser chip in which a first optical waveguide for guiding laser light to be emitted is formed; and
a silicon substrate provided with a mesa structure in which a second optical waveguide is formed,
wherein the semiconductor laser chip is flip-chip mounted on the silicon substrate,
an optical axis of the first optical waveguide makes a specified angle with a line perpendicular to a cleavage plane of the semiconductor laser chip that is an emission surface of the first optical waveguide,
the cleavage plane of the semiconductor laser chip and a cleavage plane of the mesa structure that is an incident surface of the second optical waveguide are parallel,
an optical axis of the second optical waveguide is set so as to be parallel to refracted light produced when laser light emitted in a direction of the optical axis of the first optical waveguide and refracted at the emission surface of the first optical waveguide is refracted and becomes incident at the incident surface of the second optical waveguide, and
alignment marks are provided on the silicon substrate and the semiconductor laser chip corresponding to at least two positioning locations to enable the semiconductor laser chip to be mounted by passive alignment at a mounting position of the semiconductor laser chip on the silicon substrate, the mounting position having been decided so that laser light, which has been emitted in a direction of the optical axis of the first optical waveguide and refracted at the emission surface, is refracted at the incident surface of the second optical waveguide and becomes incident in a direction of the optical axis of the second optical waveguide.

3. The semiconductor laser module according to claim 1,
wherein the semiconductor laser chip has a distributed feedback-type laser structure, and the first optical waveguide and the second optical waveguide guide the laser light in a single mode.

4. The semiconductor laser module according to claim 1,
further comprising a spot size converter mechanism that converts a spot size of the second optical waveguide at an end surface where the first optical waveguide and the second optical waveguide face one another so that the spot size of the second optical waveguide becomes larger than a spot size of the first optical waveguide.

5. A method of manufacturing a semiconductor laser module according to claim 1, comprising:
mounting the semiconductor laser chip by passive alignment at the mounting position of the semiconductor laser chip on the silicon substrate using the alignment marks provided on the silicon substrate and the semiconductor laser chip.
